(19) United States
(12) Patent Application Publication
(10) Pub. No.: US 2014/0260885 A1
(43) Pub. Date: Sep. 18, 2014

(54) APPARATUS AND METHOD FOR CONNECTING PIPE SYSTEMS

(71) Applicant: Dennis R. Salazar, Albuquerque, NM (US)

(72) Inventor: Dennis R. Salazar, Albuquerque, NM (US)

(21) Appl. No.: 13/844,831

(22) Filed: Mar. 16, 2013

(51) Int. Cl. B26D 3/00

(52) U.S. Cl. CPC B26D 3/00
USPC 83/875

(57) ABSTRACT

A groove-making tool consisting of a hardened grooving-wheel that can be substituted for the cutting-wheel on any hand-held pipe-cutting tool and can make at least ore circumferential groove in a pipe. A method of coupling the pipe to a variety of standard off-the-shelf components by placing at least one O-ring on the grooved pipe, which has thus become a universal fitting, and applying a visually identifiable adhesive and/or crimping with a crimp tool.

This application is a continuation-in-part of application Ser. No. 13/788,254, filed on Mar. 7, 2013 by Dennis R. Salazar.

### BACKGROUND OF THE INVENTION

1. Field of the Invention

The present invention generally relates to a groove-making device to allow for at least one groove to be applied to a pipe and at least one elastomeric O-ring to be applied to the groove(s), turning the pipe into a universal fitting. The invention also describes a method of fixedly and sealingly coupling the pipe to standard components with a visually identifiable flexible adhesive and/or a crimp tool.

2. Description of the Prior Art

There are a variety of methods and apparatuses for joining two components in a manner that couples the components to one another. The most common relates to the coupling of copper tubing that is employed to transport water in a building. Soldering/brazing has long been preferentially used for the connection of standard components of copper supply and distribution systems for potable water, especially in residential constructions. Changes in modern plumbing codes have mandated the use of lead-free solders and water-soluble fluxes and as such, the difficulty in making solder/braze connections has significantly increased, particularly where larger diameter copper tubing is used. In addition, soldering/brazing can be time consuming and, in some cases, dangerous.

As an alternative to solder connections it was proposed that a two-part epoxy be employed to adhesively couple tubing and components to one another. Such epoxies have performed well in fixedly coupling components to one another but have not performed well in forming a seal between the components. Analyses reveal a failure of the seal wherein the sliding of the fitting onto the tubing (or the tubing into the fitting) scrapes the epoxy off small portions of the tubing and/or the fitting so that a void is formed therebetween. While the epoxy generally has sufficient strength to couple the fitting and the tubing together fixedly, the presence of the void renders the joint unsuitable for its intended function (e.g., to communicate a fluids or gases without leaking).

A connection process that employs fittings that contain internal seals wherein the fittings are crimped directly to lengths of conventional hard drawn copper tubing is disclosed by Viega GmbH & Co. KG of Attendorn, Germany. Viega markets these systems as Propress® and Profipress®, which include an inner O-ring seal that is carried on an inner diameter of the fittings and which sealingly engages the copper tubing upon insertion into the fitting. A crimping tool is subsequently employed to crimp the fitting to the tubing to thereby fixedly couple the tubing and the special fitting to one another. This system, however, is known to suffer from several drawbacks.

Firstly, the aforementioned fittings, which contain the O-ring, require special manufacture and are far more expensive than traditional off-the-shelf fittings. Secondly, it is known that these crimped fittings have a lower pressure rating than a soldered joint. It is also known, under extreme pressures such as those present in freeze conditions, that these crimped Propress® and Profipress® fittings slide from their secure positions.

Yet another connection process, described in U.S. Pat. No. 8,083,268, employs a special fitting similar to the Propress® and Profipress® systems, but also uses a two-part epoxy to fixedly and sealingly couple components. However, this system also requires the use of costly non-standard fittings.

U.S. Pat. No. 6,641,178 describes an assembly and method whereby a pipe is grooved and cut simultaneously by a specially designed tool, then fitted with an O-ring, and then fitted into a specially designed fitting. This assembly and method are decent in providing the user a means of utilizing standard off-the-shelf components. Users of this system are unable to modify an existing tool to perform the cut/groove and the fitting is non-standard. The use of non-standard tools and fittings to make this assembly costs more and requires more time from the user.

The disadvantages inherent to these systems limit their viability by significantly adding to the cost of a project, or by making the process cumbersome, time consuming, and/or dangerous. Existing pipe joining methods and apparatuses are deficient in providing a means for plumbers to fixedly and sealingly couple standard off-the-shelf components to one another without the use of torch and solder or expensive components.

### SUMMARY OF THE INVENTION

The present invention is a portable, hand-held pipe-grooving tool, which can readily be used to create at least one groove in a pipe. By placing at least one O-ring in the groove(s), the pipe has become a universal fitting, which can be fixedly and sealingly coupled with standard off-the-shelf components.

It is a primary object of the present invention to provide a portable, hand-held pipe grooving tool and method of joining pipe systems for use as a conduit and/or for the transport of liquids or gases.

It is another object of the present invention to provide a portable, hand-held pipe grooving tool and method of joining pipe systems that will allow for the use of standard off-the-shelf components, at a significant savings compared to specialty fittings.

It is a further object of the present invention to provide a portable, hand-held pipe grooving tool and method of joining pipe systems that will couple components in such a way as to provide visually identifiable evidence that a joint has been fixedly sealed.

It is still another object of the present invention to provide a portable, hand-held pipe grooving tool and method of joining pipe systems that will significantly improve the ability of the user to rapidly plumb a pipe system safely and economically.

These and other objects of the present invention will become apparent to those skilled in the art upon reading the accompanying description, drawings, and claims set forth herein. The headings provided are for the convenience of the reader only. No headings should be construed to limit the content in any way.

### BRIEF DESCRIPTION OF THE DRAWINGS

The benefits of the present invention are evident from the subsequent description, the included claims, and the attached drawings wherein:

FIG. 1A is a frontal view of one embodiment of the grooving-wheel,

FIG. 1B is a side view of the same,

FIG. 2A is a frontal view of the grooving-wheel with a shoulder to set groove depth,

FIG. 28 is a side view of the same,

FIG. 3A is a longitudinal view of pipe with a single groove,

FIG. 3B is a longitudinal view of a pipe with an O-ring set into the groove,

FIG. 4A is a longitudinal view of a pipe with two grooves.

FIG. 4B is a longitudinal view of a pipe with two O-rings set in the grooves,

FIG. 5A is a longitudinal view of an assembly constructed according to the present invention,

FIG. 58 is a longitudinal cross-section of the assembly in FIG. 5A,

FIG. 5C is an enlarged portion of FIG. 5B,

FIG. 6A is a longitudinal view of another assembly constructed according to the present invention,

FIG. 6B is a longitudinal cross-section of the assembly in FIG. 6A.

FIG. 6C is an enlarged portion of FIG. 6B,

FIG. 7A is a longitudinal view of another assembly constructed according to the present invention,

FIG. 7B is a longitudinal cross-section of the assembly in FIG. 7A,

FIG. 7C is an enlarged portion of FIG. 7B,

FIG. 8 is a frontal view of a grooving-wheel formed with an adjacent cutting-wheel,

FIG. 9 is a frontal view of a shouldered grooving-wheel formed with an adjacent cutting-wheel,

FIG. 10 is a frontal view of a dual grooving-wheel formed with an adjacent cutting wheel,

FIG. 11 is a frontal view of shouldered dual grooving-wheel formed with an adjacent cutting-wheel.

FIG. 12 is a frontal view of a grooving-wheel formed with an adjacent spacing section.

FIG. 13 is a frontal view of a shouldered grooving-wheel formed with an adjacent spacing section,

FIG. 14 is a frontal view of a dual grooving-wheel formed with an adjacent spacing section,

FIG. 15 is a frontal view of a shouldered dual grooving-wheel formed with an adjacent spacing section.

### DETAILED DESCRIPTION OF THE INVENTION

### 1. Definitions

Pipes as used herein shall mean any metal tube intended for use as a conduit or for the transport of liquids or gases.

O-rings as used herein shall mean any elastomeric sealing ring.

Standard components as used herein shall mean any conventional solder/braze fitting or coupling component that can be readily found at hardware stores.

### 2. Best Mode of the Invention

The best mode of the present invention as contemplated by the inventor, as is seen in the drawings, provides a hardened metal grooving-wheel 30 or 32 that will be substituted for the replaceable cutting wheel in any hand-held pipe-cutting tool. This modification has repurposed the tool to become a portable, hand-held pipe-grooving device, allowing for at least one circumferential groove 70 to be made in a pipe 20. After placing at least one O-ring 50 in place the groove(s), the grooved pipe 20 becomes a dual-use universal fitting, which still performs its intended function as a conduit, while at the same time allows the pipe 20 to be fixedly and sealingly coupled with standard components 10. The O-ring 50 will circumferentially engage the outer diameter of the pipe 20 and the inner diameter of the standard component 10 and will create a seal therebetween. A colored adhesive 60 will be applied to the joint, from the inserted end of the pipe 20 to a distance past the end of the standard component 10, to fixedly couple the pipe 20 to the standard component 10 and provide visual evidence that the joint is fixed. A crimp can also be applied to deform/dimple 40 the pipe 20 and standard component 10 to one another.

### 3. How to Make the Invention

It is well known to those skilled in this at that there are many variations of hand-held pipe-cutting tools. The most common are pipe-cutting tools in which the sizing and cutting actions are performed manually. However there are several power driven pipe-cutting tools that size and cut automatically. All of these pipe-cutting tools allow the user to replace the cutting-wheel when it dulls. As can be seen by the drawings, a hardened metal grooving-wheel 30 or 32 can be substituted for the replaceable cutting-wheel according to the present invention.

A grooving-wheel 30 can be substituted for the replaceable cutting-wheel in a hand-held pipe-cutting tool where the frame of the tool upon which the wheel is mounted acts as a stop relative to the diameter of the grooving-wheel 30 to set the depth of the circumferential grove 70 made by the grooving wheel 30 on a pipe 20. The grooving-wheel can be of a variety of diameters, matching the diameter of the cutting-wheel being replaced. A preferred cutting tool that can be modified in this manner is the HandPaw Ratcheting Pipe-Cutter made by HandPaw Tools Co., Ltd. No. 411 Si-Hu Rd., Tali Dist., Taichung City, Taiwan 412

A shouldered grooving-wheel 32 can also be substituted for the replaceable cutting-wheel in a hand-held pipe-cutting tool where the frame of the tool upon which the wheel is mounted does not act as a stop to set the depth of the circumferential groove 70 made by the grooving-wheel 32. The shoulders 34, formed on each side of the shouldered grooving-wheel 32 set the depth of the groove 70 made by the grooving-wheel 32. The grooving-wheel can be of a variety of diameters, matching the diameter of the cutting-wheel being replaced. A preferred cutting-tool that can be modified in this manner is the M12™ Cordless Lithium-Ion Copper Tubing Cutter made by Milwaukee Electric Tool Corporation 13135 West Lisbon Road, Brookfield, Wis. 53005

A grooving-wheel 30 can also be formed with an adjacent cutting-wheel 35, so that a cut can be made simultaneously with a groove as shown in FIG. 8.

A shouldered grooving-wheel 32 can also be formed with an adjacent-cutting-wheel 35, so that cut can be made simultaneously with a groove as shown in FIG. 9.

A dual grooving-wheel 30 can also be formed with an adjacent cutting-wheel 35, so that a cut can be made simultaneously with a groove as shown in FIG. 10.

A shouldered dual grooving-wheel 32 can also be formed with an adjacent cutting-wheel 35, so that a cut can be made simultaneously with a groove as shown in FIG. 11.

A grooving-wheel 30 can also be formed with an adjacent spacing section so that the grooving-wheel can be placed alongside a separate, existing cutting-wheel 36 as shown in FIG. 12.

A shouldered grooving-wheel 32 can also be formed with an adjacent spacing section so that the grooving-wheel can be placed alongside a separate, existing cutting-wheel 36 as shown in FIG. 13.

A dual grooving-wheel 30 can also be formed with an adjacent spacing section so that the grooving-wheel can be placed alongside a separate, existing cutting-wheel 36 as shown in FIG. 14.

A shouldered dual grooving-wheel 32 can also be formed with an adjacent spacing section so that the grooving-wheel can be placed alongside a separate, existing cutting-wheel 36 as shown in FIG. 15.

Once the pipe 20 receives at least one circumferential groove 70, at least one O-ring 50 is placed in the circumferential groove(s) 70, where up to 40% of the O-ring(s) 50 is visible above the outer diameter of the pipe 20. The pipe 20 has now become a universal fitting.

Also shown in the drawings are assemblies constructed according to the present invention, where the pipe 20 contains at least one circumferential groove 70 made by the grooving-wheel 30 or 32, and at least one O-ring 50 has been inserted into the circumferential groove(s) 70. A colored adhesive 60 is applied to either the outer surface of the pipe 20 and/or the inner surface of the standard component 10. The pipe 20 is inserted into a standard component 10 and at least one crimp can be applied with a crimp tool to symmetrically deform/dimple 40 the pipe 20 and the standard component 10, fixedly securing them to one another.

The O-ring(s) 50 engage the outer diameter of the pipe 20 and the inner diameter of the standard component 10, forming a seal.

The colored adhesive 60 fixedly couples the pipe 20 to the standard component 10 and provides visual evidence that the joint is fixed. The colored adhesive would be one that not only adhesively couples the pipe 20 to the standard component 10, but one that also has slight flexibility to allow the joint to flex naturally under dynamic conditions.

The crimp tool can be apply at least one dent/dimple to the outer diameter of the standard component 10 in order to further secure the pipe 20 to the standard component 10 and also to provide further visual evidence that the joint has been fixed.

### 4. How to Use the Invention

The great many problems solved by the present invention can be easily seen by those skilled in this art. There are thousands of fires started by plumbers soldering torches every year, resulting in loss of life, injury, and hundreds of millions of dollars in property toss. The present invention makes it possible to connect pipe systems without the use of torch and solder, which in many cases is difficult or dangerous, as it poses a fire hazard in enclosed spaces. The present invention saves the user a significant amount of time when connecting pipe systems compared to the use of torch and solder. It also allows for a user of limited plumbing skills to fixedly and sealingly connect pipe systems. The use of a portable, hand-held grooving tool allows the user to create a universal fitting from ordinary lengths of pipe 20 and eliminates the need for the user to purchase specialty fittings when connecting pipe systems, saving a significant amount of money compared to other solderless systems. This system also allows for the user to quickly make custom fittings on the spot from pieces of material that the user likely has readily available on the job site. The system described in the present invention provides a means of connecting pipe systems economically, efficiently, and safely, not only by professional plumbers, but also by users all over the world who may not be skilled in the use of torch and solder.

Thus it will be appreciated by those skilled in the are that the present invention is not restricted to the particular preferred embodiments described with reference to the drawings, and that variations may be made therein without departing from the scope of the present invention as defined in the appended claims and equivalents thereof.

What is claimed is:

1. A portable hand-held grooving-tool comprising: a metal grooving-wheel formed with an adjacent cutting wheel that can be substituted for the cutting-wheel in a portable hand-held pipe-cutting tool.

2. A portable hand-held grooving-tool according to claim 1 where the grooving-wheel is a hardened metal alloy.

3. A portable hand-held grooving-too according to claim 1 where the grooving-wheel is rotatably mounted to the body of the tool by a removable axle pin.

4. A portable hand-held grooving-tool comprising: a shouldered metal grooving-wheel formed with an adjacent cutting-wheel that can be substituted for the cutting-wheel in a portable hand-held pipe-cutting tool.

5. A portable hand-held grooving-too according to claim 4 where the grooving-wheel is a hardened metal alloy.

6. A portable hand-held grooving-tool according to claim 4 where the grooving-wheel has two shoulders formed on either side in order to set the depth of the groove made by the grooving-wheel.

7. A portable hand-held grooving-tool according to claim 4 where the grooving-wheel is rotatably mounted to the body of the tool by a removable axle pin.

8. A portable hand-held grooving-tool comprising: a metal dual grooving-wheel formed with an adjacent cutting-wheel that can be substituted for the cutting-wheel in a portable hand-held pipe-cutting tool.

9. A portable hand-held grooving-tool according to claim 8 where the grooving-wheel is a hardened metal alloy.

10. A portable hand-held grooving-tool according to claim 8 where the grooving-wheel is rotatably mounted to the body of the tool by a removable axle pin.

11. A portable hand-held grooving-tool comprising: a shouldered, metal, dual grooving-wheel formed with an adjacent cutting wheel that can be substituted for the cutting-wheel in a portable hand-held pipe-cutting tool.

12. A portable hand-held grooving-tool according to claim 11 where the grooving-wheel is a hardened metal alloy.

13. A portable hand-held grooving-tool according to claim 11 where the grooving-wheel has two shoulders formed on either side in order to set the depth of the groove made by the grooving-wheel.

14. A portable hand-held grooving-tool according to claim 11 where the grooving-wheel is rotatably mounted to the body of the tool by a removable axle pin.
